(19) United States
(12) Patent Application Publication
(10) Pub. No.: US 2021/0307552 A1
(43) Pub. Date: Oct. 7, 2021

(54) COOKING DEVICE AND COMPONENTS THEREOF

(71) Applicant: SHARKNINJA OPERATING LLC, Needham, MA (US)

(72) Inventors: Rupert Elliston, London (GB); Steven Carter, London (GB); Andrew John Roy Tattersfield, London (GB); Joshua D. Anthony, North Billerica, MA (US); Benjamin Sharp, Cumbria (GB); Gregory Fish, Jamaica Plain, MA (US)

(21) Appl. No.: 17/221,325

(22) Filed: Apr. 2, 2021

Related U.S. Application Data
(60) Provisional application No. 63/004,544, filed on Apr. 3, 2020.

(51) Int. Cl. A47J 27/082; A47J 37/06; A47J 27/086; F24C 7/06

(52) U.S. Cl. CPC A47J 27/082; A47J 37/0641; F24C 7/067; A47J 27/086; A47J 37/0664

(57) ABSTRACT

A cooking system for cooking food includes a housing defining a hollow chamber, a food container positionable in said hollow interior and defining a container interior, and at least one heating element positioned in said housing to heat said container interior. The food container includes a non-elliptical container shape and the housing includes a non-elliptical housing shape. The container interior is structured to tolerate a high pressure cooking environment.

### CROSS-REFERENCE TO RELATED APPLICATIONS

This application claims the benefit of U.S. Provisional Application Ser. No. 63/004,544 filed Apr. 3, 2020, the disclosure of which is incorporated herein by reference in its entirety.

### BACKGROUND

Embodiments of the present disclosure relates generally to a cooking device and components thereof, and more specifically, to a food container suitable for use in a cooking system.

Conventional cooking devices, such as pressure cookers and air fryers each perform a single cooking operation, and as such, these devices employ different components and method for cooking food items. In an effort to reduce the total number of appliances needed by a user, multiple devices, which perform various cooking operations, have been developed. However, the space available for cooking food in such a multi-functional cooker is typically limited. Accordingly, it is desirable to develop a cooking system capable of increasing the area for cooking food, without increasing the countertop space that the multi-functional cooker occupies.

### SUMMARY

According to an embodiment, a cooking system for cooking food includes a housing defining a hollow chamber, a food container positionable in said hollow interior and defining a container interior, and at least one heating element positioned in said housing to heat said container interior. The food container includes a non-elliptical container shape and the housing includes a non-elliptical housing shape. The container interior is structured to tolerate a high pressure cooking environment.

In addition to one or more of the features described above, or as an alternative, in further embodiments said non-elliptical container shape is the same or similar to said non-elliptical housing shape.

In addition to one or more of the features described above, or as an alternative, in further embodiments said non-elliptical container shape and said non-elliptical housing shape are squircle shaped.

In addition to one or more of the features described above, or as an alternative, in further embodiments said high pressure cooking environment reaches a pressure of at least 70 kPa.

In addition to one or more of the features described above, or as an alternative, in further embodiments said high pressure cooking environment reaches a pressure of between 40 kPa and 100 kPa.

In addition to one or more of the features described above, or as an alternative, in further embodiments said hollow interior of said housing includes a non-elliptical shape that is the same or similar to said non-elliptical container shape.

In addition to one or more of the features described above, or as an alternative, in further embodiments said at least one heating element is a heating element disposed below said food container.

In addition to one or more of the features described above, or as an alternative, in further embodiments said at least one heating element is a heating element disposed above said food container.

In addition to one or more of the features described above, or as an alternative, in further embodiments said at least one heating element is a first heating element disposed below said food container and a second heating element disposed above said food container.

In addition to one or more of the features described above, or as an alternative, in further embodiments a thickness of said food container varies about a perimeter of the food container.

In addition to one or more of the features described above, or as an alternative, in further embodiments said food container has a plurality of sides connected by a plurality of rounded corners and a thickness of said food container at at least one of the plurality of rounded corners is greater than a thickness of said food container at at least one of the plurality of sides.

According to another embodiment, a cooking system for cooking food includes a housing defining a hollow chamber, a food container positionable in said hollow interior and defining a container interior, and at least one heating element positioned in said housing to heat said container interior. The food container includes at least one first wall area and at least one second wall area, and at least one first wall area including a greater fortification for stress tolerance than said at least one second wall area.

In addition to one or more of the features described above, or as an alternative, in further embodiments said container interior is structured to tolerate a high pressure cooking environment.

In addition to one or more of the features described above, or as an alternative, in further embodiments said high pressure cooking environment reaches a pressure of at least 70 kPa.

In addition to one or more of the features described above, or as an alternative, in further embodiments said high pressure cooking environment reaches a pressure of between 40 kPa and 100 kPa.

In addition to one or more of the features described above, or as an alternative, in further embodiments said food container includes a non-elliptical container shape.

In addition to one or more of the features described above, or as an alternative, in further embodiments said food container includes a squircle container shape.

In addition to one or more of the features described above, or as an alternative, in further embodiments said food container includes a plurality of sides extending between a plurality of rounded corners, said at least one first wall area including one of the plurality of rounded corners and said at least one second wall area including one of the plurality of sides.

In addition to one or more of the features described above, or as an alternative, in further embodiments said at least one first wall area includes a first thickness and said at least one second wall area includes a second thickness, said first thickness being greater than said second thickness, said greater fortification for stress tolerance being formed by said first thickness.

In addition to one or more of the features described above, or as an alternative, in further embodiments said at least one heating element is a heating element disposed below said food container or above said food container.

### BRIEF DESCRIPTION OF THE FIGURES

The accompanying drawings incorporated in and forming a part of the specification embodies several aspects of the present disclosure and, together with the description, serves to explain the principles of the disclosure. In the drawings:

FIG. 1A is a perspective front view of the cooking system according to an embodiment;

FIG. 1B is a bottom view of the cooking system according to an embodiment;

FIG. 1C is a side by side front view the cooking system according to an embodiment;

FIG. 1D is a rear view of the cooking system according to an embodiment;

FIG. 2 is a perspective view of the cooking system having a lid in an open position according to an embodiment;

FIG. 3A is a cross-sectional view of the cooking system having a secondary lid according to an embodiment;

FIG. 3B is a front view of a cooking system having a secondary lid according to an embodiment;

FIG. 4 is a perspective view of a lid of the cooking system according to an embodiment;

FIG. 5 is a perspective view of a cooking container according to an embodiment;

FIG. 6 is plan view of the cooking container of FIG. 5 according to an embodiment;

FIG. 7 is a perspective view of a portion of a cooking system according to an embodiment;

FIG. 8 is a schematic diagram of the cooking system according to an embodiment;

FIG. 9 is a block diagram illustrating a control path for a cooking system according to an embodiment;

FIG. 10A is a perspective view of an air diffuser according to an embodiment;

FIG. 10B perspective lower view of an insert according to an embodiment;

FIG. 10C is a perspective view of an insert with attached diffuser according to an embodiment;

FIG. 11 is a cross-sectional view of the cooking system according to an embodiment;

FIG. 12 is a table showing cooking parameters for use in a cooking system according to an embodiment;

The detailed description explains embodiments of the disclosure, together with advantages and features, by way of example with reference to the drawings.

### DETAILED DESCRIPTION

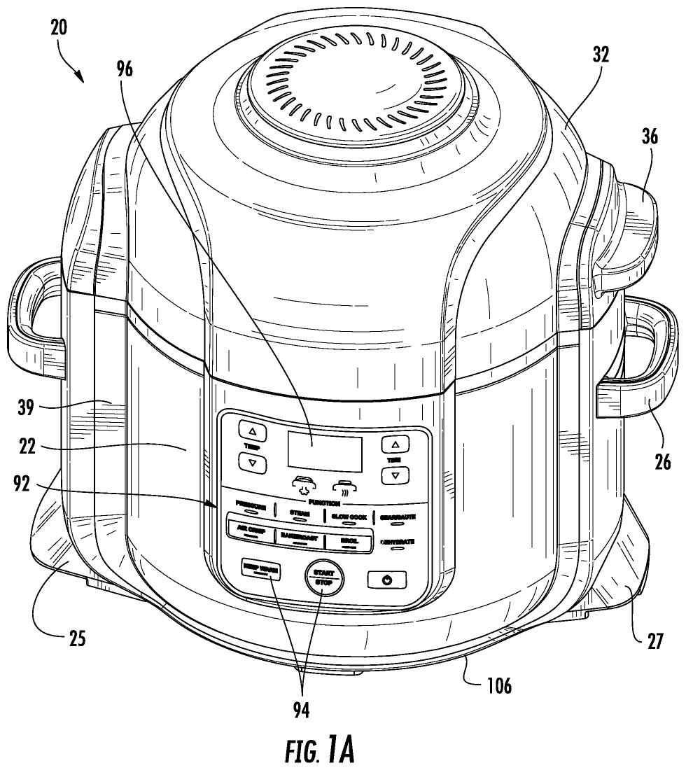

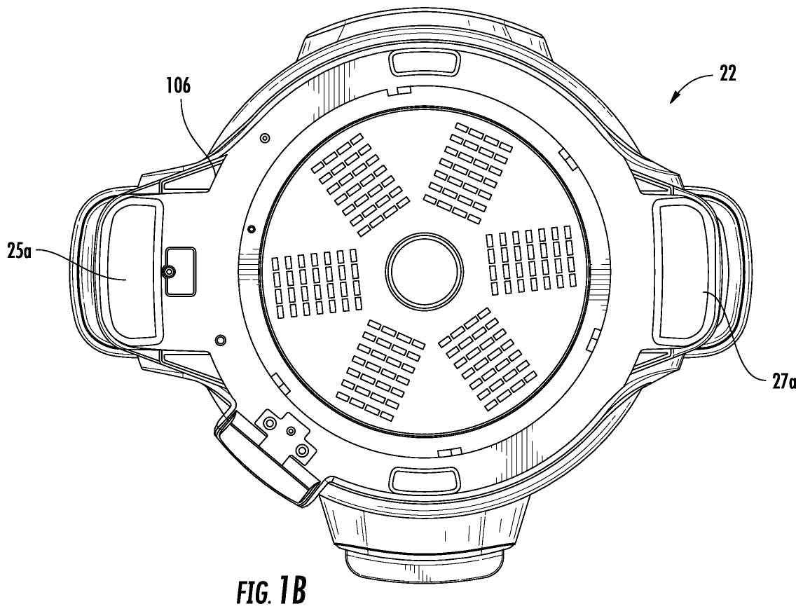

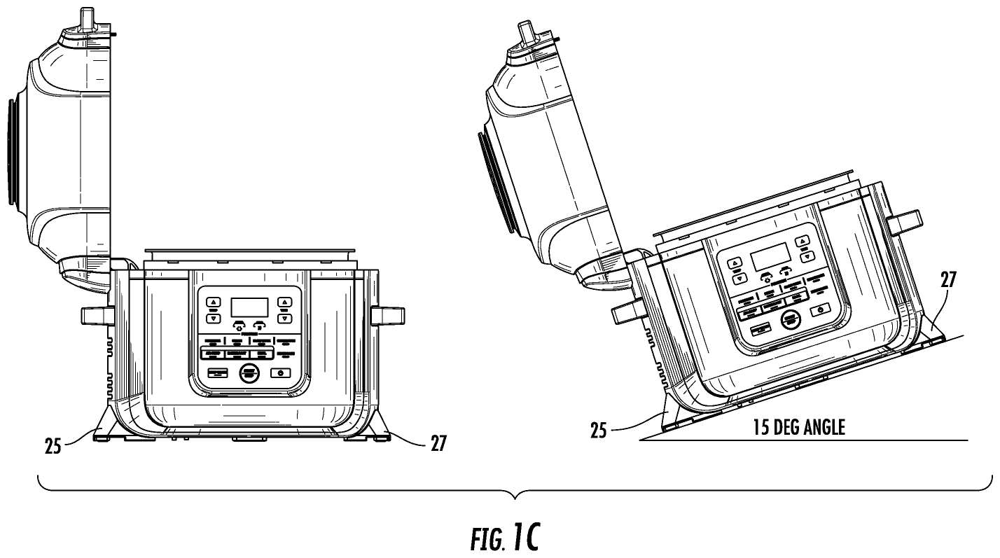

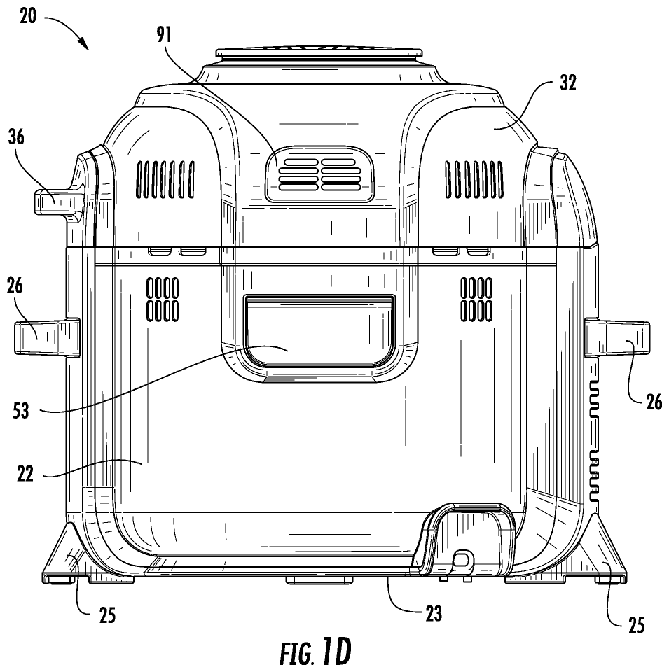

With reference first to FIGS. 1-7, a cooking system 20 configured to perform multiple cooking operations is illustrated. As shown, the cooking system 20 includes a housing 22 and a first or primary lid 32 permanently or removably attached, or more specifically hinged, to the housing 22. In an exemplary, non-limiting embodiment, the connection or hinge area between the lid 32 and the housing 22 occurs at an upper portion of a spine 39 of the housing 22. A bottom 106 of the housing 22 of the cooking system 20 (see FIG. 1B) may be supported on a surface by one or more feet 25 and 27, which may include shock absorbing pads 25a and 27a (of a material such as but not limited to rubber) at a bottom surface thereof. The feet 25, 27 may extend from the housing 22 to define a surface on which the cooking system 20 may contact an adjacent supporting surface, such as a countertop for example. The bottom surface of the feet 25, 27 or pads 25a, 27a may be flush with, or alternatively, may extend out of plane from the bottom 106 of the housing. In the illustrated, non-limiting embodiment, the housing 22 includes two feet 25, 27 arranged on opposing sides of the housing 22; however, it should be understood that a housing having any suitable number of feet 25 is within the scope of the disclosure.

Referring now to some of the interior features of the system 20, an inner surface of the housing 22 defines a hollow interior 30. In an exemplary non-limiting embodiment, a liner 23 that may be formed from any suitable conductive material, such as aluminum for example is disposed within the hollow interior 30, and in some embodiments the liner 23 may be the inner surface defining the hollow interior (though surfaces inside the liner 23, such as the walls of the container, or outside the liner 23, such as plastic around the liner 23, may also define the hollow interior 30).

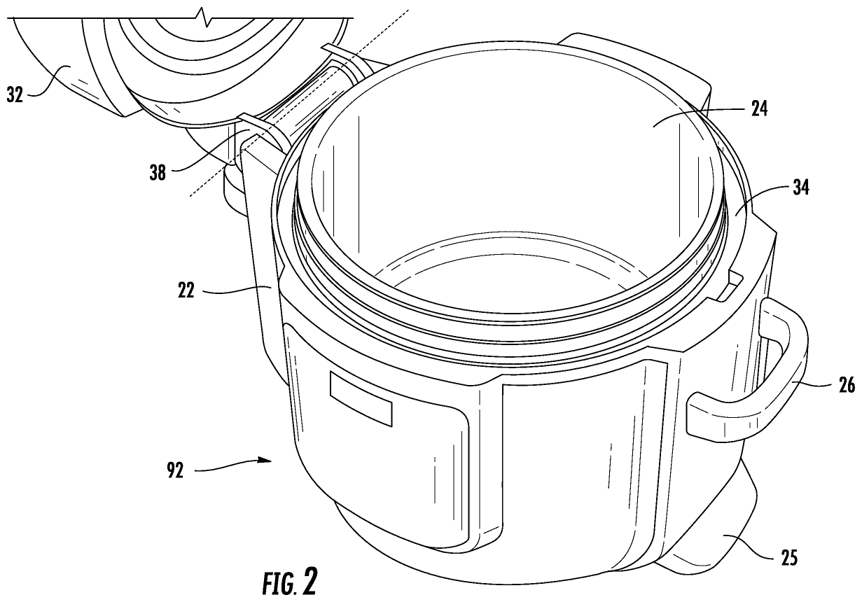

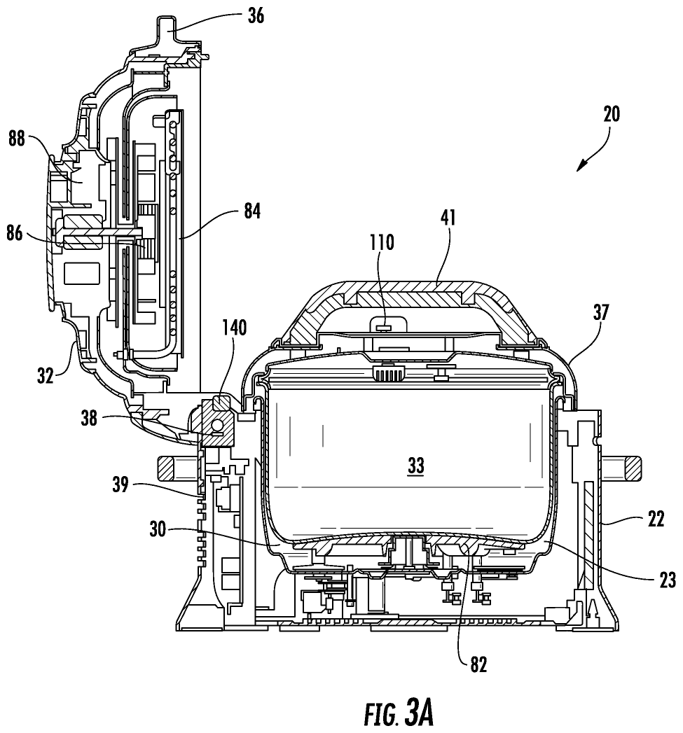

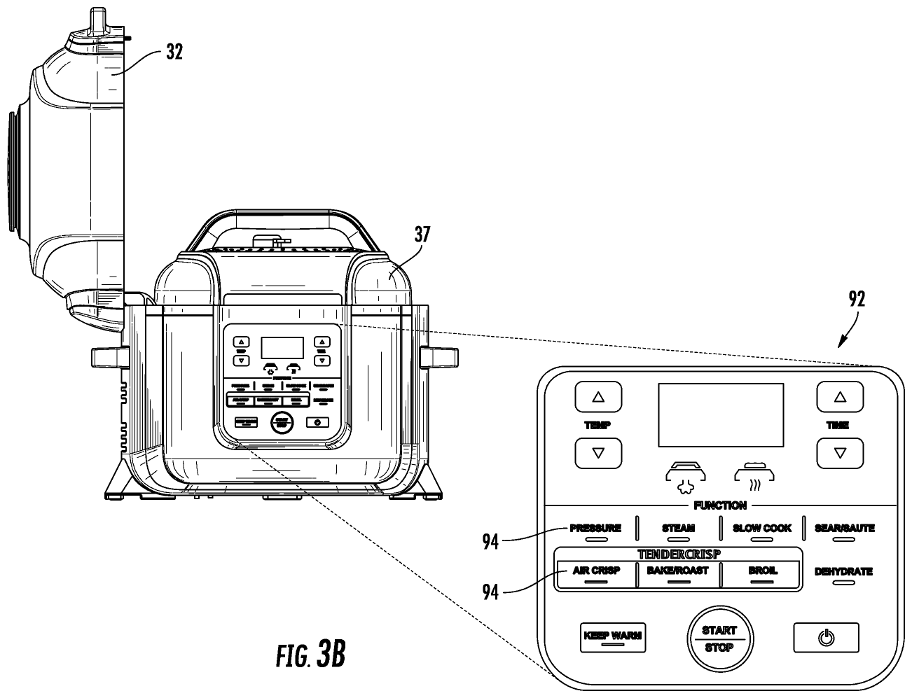

In an exemplary, non-limiting embodiment, a food container 24 is receivable inside the hollow interior 30 defined by the liner 23. Spacing components, such as silicone bumpers (not shown) may be disposed along the inner surface of the liner 23 to keep the container 24 aligned properly within the hollow interior 30 during cooking. Although the container 24 is described herein as being removable from the housing 22, embodiments where the container 24 is integrally formed with the housing 22 are also contemplated herein. The container 24, which is shown in FIGS. 2 and 3A, has an interior 33 designed to receive and retain one or more consumable products, such as food products for example, therein. Examples of food products suitable for use with the cooking system 20, include but are not limited to, meats, fish, poultry, bread, rice, grains, pasta, vegetables, fruits, and dairy products, among others. The container 24 may be a pot formed from a ceramic, metal, or die cast aluminum material. In an embodiment, an interior surface of the container 24 includes a nano ceramic coating and an exterior surface of the container 24 includes a silicone epoxy material. However, any suitable material capable of withstanding the high temperatures and pressures required for cooking food products is contemplated herein.

Referring with more detail not to the lid 32, it should be noted that the lid 32 is connectable to a surface of the container 24 and/or housing 22 to close off entry to the hollow interior 30 of the container 24. In an embodiment, a diameter of the lid 32 is generally complementary to a diameter of the housing 22 such that the lid 32 covers not only the container 24, but also an upper surface 34 of the housing 22. The lid 32 can be made of any suitable material, such as glass, aluminum, plastic, or stainless steel for example. Further, the lid 32 may, but need not, include one or more handles 36 for removably coupling the lid 32 to the remainder of the cooking system 20. In the illustrated, non-limiting embodiment, the lid 32 is coupled to the housing 22 via a hinge 38 (best shown in FIG. 3A just above the spine 39), such that the lid 32 is rotatable about an axis X between an open position (FIG. 3) and a closed position (FIG. 1A). In such embodiments, the hinge axis X may be located at a side surface of the cooking system 20, as shown in FIG. 2, or alternatively, at a back surface of the cooking system 20, such as vertically disposed relative to one or more handles 26 of the housing 22, as shown in FIG. 3A. However, embodiments where the lid 32 is separable from the housing 22, or movable between the open and closed positions in another manner are also contemplated herein. One or more fastening mechanisms (not shown) may, but need not be used to secure the lid 32 to the housing 22 when the lid 32 is in the closed position. Any suitable type of fastening mechanism capable of withstanding the heat associated with the cooking system 20 is considered within the scope of the disclosure.

In an embodiment, best shown in FIGS. 3A-B, and 4, the cooking system 20 additionally includes a secondary lid 37 configured to removably couple to the housing 22 and/or container 24 to seal the hollow interior 30. In an embodiment, the secondary lid 37 is press-fit onto an upper surface 34 of the housing 22 or directly to the container 24. In another embodiment, the secondary lid 37 is configured to thread-ably couple to the upper surface 34 of the housing 22 or the container 24. However, embodiments where the secondary lid 37 is configured to couple to at least one of the housing 22 and container 24 in another suitable manner, such as via a pressure tight mechanism for example, are also contemplated herein. The secondary lid 37 can be made of any suitable material, such as glass, aluminum, plastic, or stainless steel, or any combination thereof for example. In an embodiment, the secondary lid 37 is formed from a molded plastic material. In addition, the secondary lid 37 may, but need not, include one or more handles 41 for removably coupling the secondary lid 37 to the cooking system 20. The handle 41 may be integrally formed with the remainder of the secondary lid 37, such as via a molding process, or alternatively, may be a separate component coupled to the secondary lid 37.

It should be noted that in an exemplary embodiment the secondary lid 37 is a pressure lid. That is, the secondary lid 37 is fastenable to the housing 22 in a manner that creates a pressure tight seal with an upper portion of the container 24. This seal can be achieved by locking the lid to the housing 22, while a component of the secondary lid 37, such as a flexible/resilient gasket, forms the pressure tight seal with the upper portion of the container 24. This gasket may be made of rubber, silicone, or other similar materials.

By affixing the secondary lid 37 to the housing 22 and food container 24, a cooking volume may be defined between the interior 33 of the food container 24 and the closed secondary lid 37. Within this volume, a high pressure cooking environment is achievable, with pressure levels reaching at least 40 kPa, and in some instances at least 70 kPa. Pressure ranges between 40 kPa and 100 kPa, as well as between 70 kPa and 100 kPa are contemplated, and may reach a threshold of 100 kPa, 200 kPa, 300 kPa, 400 kPa, 500 kPa, or even greater.

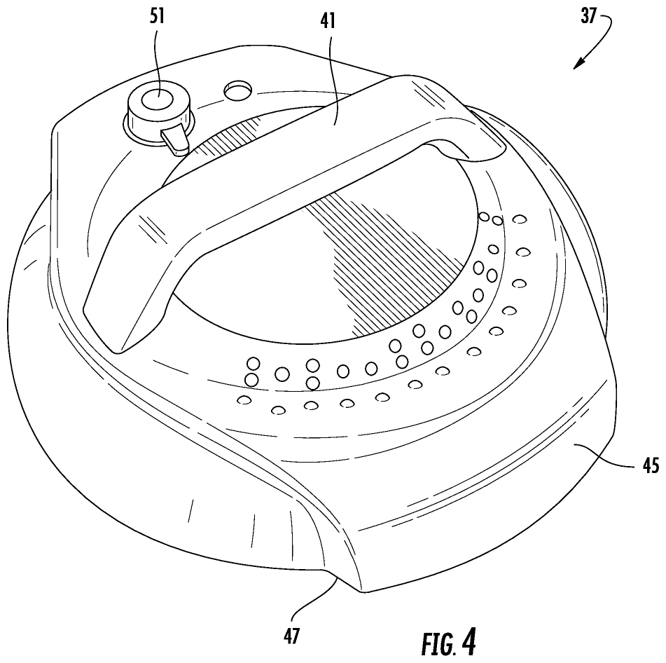

Further, a pressure relief valve 51 (see FIG. 4) is formed in a surface of the secondary lid 37, such as the upper surface thereof for example. The pressure relief valve is configured to automatically open to release air from within the chamber formed between the secondary lid 37 and the container 24 when the pressure therein exceeds a predetermined threshold. Alternatively, or in addition, the pressure relief valve is manually operable to release air from within the chamber formed between the secondary lid 37 and the container 24. In a closed position, the pressure relief valve 51 prevents steam (or air and/or other fluids) from leaving the interior 33 of the food container 24. In an open position, the pressure relief valve 51 allows steam (or air and/or other fluids) to exit the interior 33 of the food container 24.

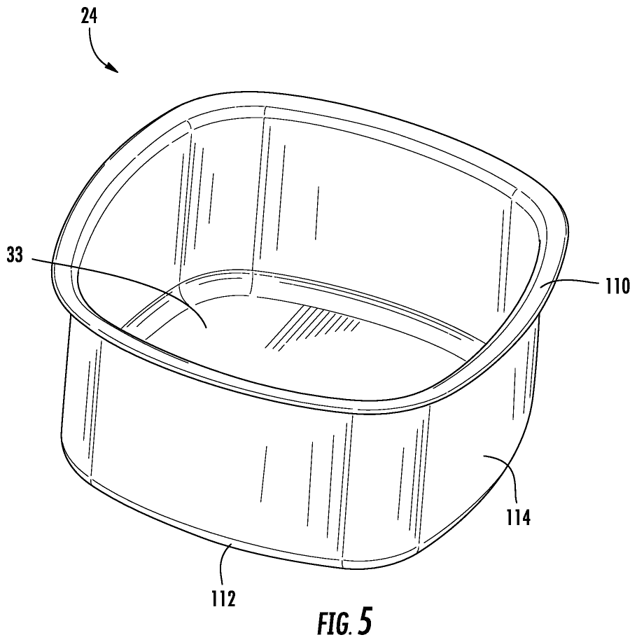

To couple the secondary lid 37 to the housing 22, the primary lid 32 must be in an open position, as shown in FIGS. 3A and 3B. Further, in an embodiment, the primary lid 32 is not movable to the closed position relative to the housing 22 when the secondary lid 37 is affixed thereto. This may be due to the outer diameter of the secondary lid 37, or alternatively, because one or more components extending upwardly from the lid 37, such as handle 41, would interfere with a portion of the primary lid 32. However, in other embodiments, as shown in FIGS. 4 and 5, at least a portion of the secondary lid 37 may be nestable or receivable within the primary lid 32. In such embodiments, the outer diameter of the secondary lid 37 may be smaller than the inner diameter of the primary lid 32, such that the primary lid 32 substantially surrounds the secondary lid 37 when in the closed position. Accordingly, the enclosure defined by the hollow interior 30 of the container 24 and the secondary lid 37 is smaller than the enclosure formed by the hollow interior 30 of the container 24 and the primary lid 32. Although the cooking system 20 is illustrated and described herein including the secondary lid 37, it should be understood that in some embodiments the cooking system 20 includes only a primary lid 32 and does not include a secondary lid 37.

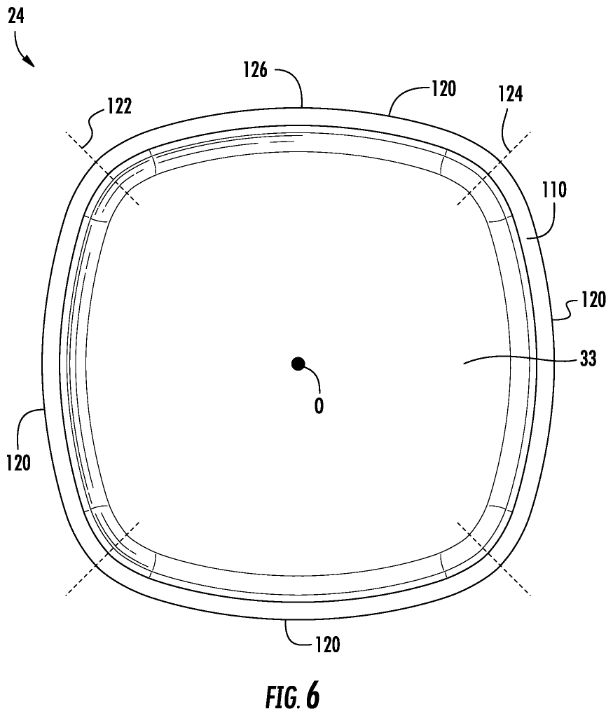

With reference now to FIGS. 5-7, an example of the food container 24 is illustrated in more detail. As shown, the food container 24 includes a first open end 110, a second closed end 112, and at least one sidewall 114 extending between the closed end 112 and the open end 110 to define the hollow interior 33. Unlike existing cooking systems, and specifically systems operable to perform a pressure cooking operation, the food container 24 has a non-elliptical shape. A square, rectangle, rectellipse (rectangle with rounded corners), squircle (square with rounded corners) and other non-circular or non-oval shapes are contemplated within the scope of non-elliptical. As shown in FIG. 6, the food container 24 may be symmetrical about any plane or axis extending through the center or origin O of the food container 24; however, the food container 24 is not axisymmetric about the origin O of the food container 24.

In an embodiment, the shape of the food container 24 is complementary to the shape of the housing 22. For example, both the food container 24 and the housing 22 may have the same or similar, non-elliptical shapes. Regardless of the configuration of the housing 22, the hollow interior 30 of the housing 22 may have a non-elliptical shape complementary to the size and shape of the food container 24.

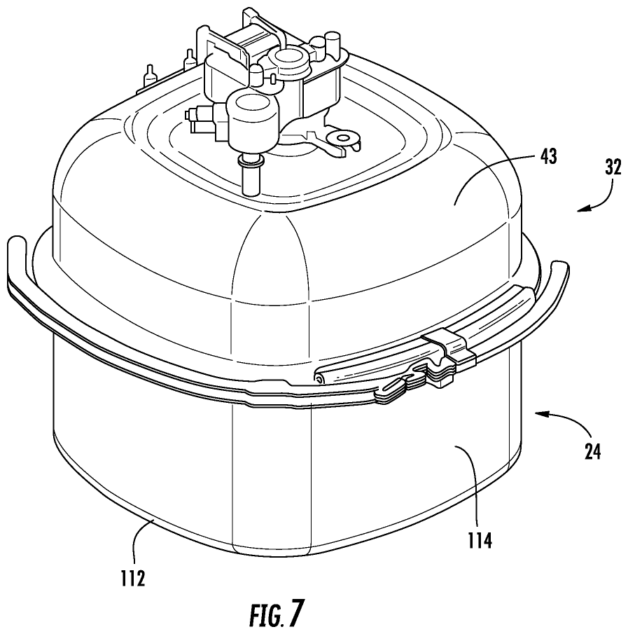

As best shown in FIG. 7, a contour of an interior 43, and in some embodiments the exterior, of either the lid 32 or the secondary lid 37, may also have a non-elliptical shape. In the illustrated, non-limiting embodiment, the non-elliptical shape of the lid 32 and/or the secondary lid 37 is the same as or is similar to the shape of the food container 24. However, in other embodiments, the shape of the food container 24 may be dissimilar from the shape of the interior 43 of the lid 32 or secondary lid 37. In such embodiments, the interior and/or exterior of the lid 32 or secondary lid 37 may, but need not have a non-elliptical shape.

In the illustrated, non-limiting embodiment, the food container 24 is squircle in shape. As used herein, the term “squircle” is intended to describe a shape formed as a combination of a circle and a square. A squircle shape includes four sides 120, generally equal in length and shape. The contour of each of the plurality of sides 120 and the interface between adjacent sides 120 is generally rounded. As best shown in FIG. 3, each of the plurality of sides 120 of the food container 24 includes a first end 122, a second, opposite end 124, and a center 126. The first end 122 and the second end 124 are located a first distance or radius from the origin or center O of the food container 24, and the center 126 of each side 120 is located a second distance or radius from the origin O of the food container 24. To achieve the generally rounded contour of each side 120 of the food container 24, the second radius at the center 126 of each side 120 is greater than the first radius at the ends 122, 124 of each side 120. As a result, each side 120 of the food container 24 has a non-uniform radius of curvature. However, embodiments where the second radius is less than the first radius are also contemplated herein. As noted above, the housing 22 or the hollow interior 30 formed therein and the lid 32 or lid 37 may have a squircle shape similar to squircle shape of the food container 24. It should be appreciated that a cooking system 20 with a food container 24, housing 22, and lid 32 or 37 having non-elliptical shapes (such as squircle shapes) as illustrated and described herein optimizes the use of counter top space occupied by the cooking system 20. As a result, the ratio of the countertop surface area occupied by the cooking system and the usable volume of the food container can be significantly increased.

A first wall area of the container 24 includes a greater fortification for stress tolerance than a second wall area of the container. In an embodiment, greater fortification for stress tolerance at the first wall area is achieved by increasing the thickness at the first wall area. As a result, the thickness of the sidewall 114 of the container 24 may vary about a perimeter of the container 24. The one or more areas that include greater fortification for stress tolerance include the areas of the container 24 may include stress concentrations that therefore experience greater stresses and pressures during operation of the cooking system 20. In an embodiment, the first wall area having a greater fortification for stress tolerance includes a corner of the container 24, defined by the interface between ends 122, 124 of adjacent sidewalls 120, and the second wall area includes a sidewall 120 extending from such a corner, or between two corners. However, embodiments where the first wall area includes a sidewall of the container 24 and the second wall area includes a corner of the container 24 are also within the scope of the disclosure.

Although greater fortification for stress tolerance is described herein with respect to an increased thickness of the container, it should be understood that a greater fortification may be achieved in several ways. For example, greater fortification for stress tolerance may be achieve via the geometry at the first wall area, or via material selection at the first wall area, or by affixing additional components or structures to the first wall area.

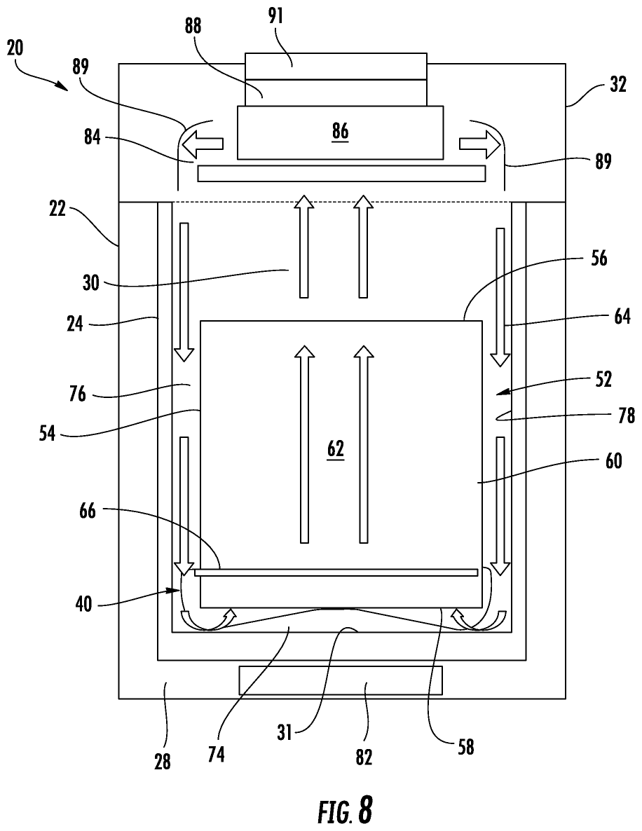

With specific reference now to FIG. 8, the cooking system 20 includes at least one first heating element 82 and at least one second heating element 84 configured to impart heat to the hollow interior and/or container 24 during various modes of operation of the cooking system 20. As shown, one or more first heating elements 82 may be disposed at the base 28 of the housing 22, generally adjacent the bottom 31 of the container 24; though, embodiments where one or more of the first heating elements 82 are arranged adjacent a side of the housing 22, in addition to or in place of the base 28 of the housing 22, are also contemplated herein. The second heating element 84 may be positioned generally at or above an upper extent of the container 24, proximate an upper opening of the container. However, in the exemplary non-limiting embodiment shown in the Figures, the second heating element 84 is disposed in the lid 32, and therefore completely outside of the container 24, above the upper extent thereof.

With reference again to FIGS. 1A, 2, and 3B, a control panel or user interface 92 of the cooking system 20 is positioned adjacent one or more sides of the housing 22. The control panel 92 includes one or more inputs 94 associated with energizing the one or more heating elements 82, 84 of the cooking system 20 and for selecting various modes of operation of the cooking system 20. One or more of the inputs 94 may include a light or other indicator to show that the respective input has been selected. The control panel 92 may additionally include a display 96 separate from and associated with the at least one input 94. However, embodiments where the display 96 is integrated into the at least one input 94 are also contemplated herein.

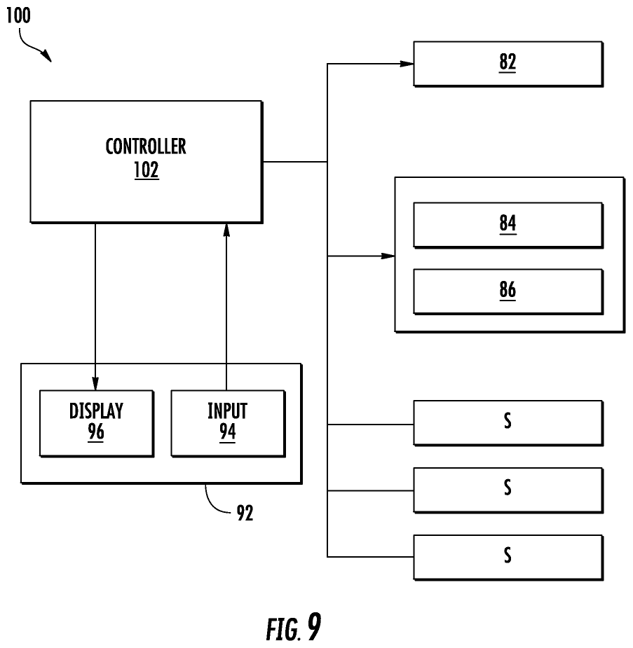

As shown in FIG. 9, a control system 100 of the cooking system 20 includes a controller or processor 102 for controlling operation of the heating elements 82, 84 (and air movement device 86 including the motor 88 and fan 90 associated therewith, which will be discussed in greater detail below), and in some embodiments for executing stored sequences of heating operation. The processor 102 is operably coupled to the control panel 92 and to the heating elements 82, 84 and the air movement device 86. In addition, in an exemplary embodiment, one or more sensors S for monitoring one or more parameters (such as temperature, pressure, lid configuration, etc.) associated with operation of the heating elements 82, 84 and/or lids 32, 37 may be arranged in communication with the processor 102. In an embodiment, a first temperature sensor extends from a bottom surface 108 of the liner 23 proximate the first heating element 82 and bottom surface of the container 24, and a second temperature sensor is located within the lid 32 proximate the second heating element 84. In such embodiments, the second sensor may be used, such as to monitor temperature for example, when the lid 32 is closed and the sensor S is arranged in fluid communication with the hollow interior 30 of the system 20. The first sensor may be used to monitor temperature in this manner, separately or in conjunction with the second temperature sensor.

The one or more inputs 94 are operable to initiate manual operation of the cooking system 20 in at least a first cooking mode and a second cooking mode. In an embodiment, the first cooking mode employs first heating element 82 to perform conductive cooking operations. Conductive cooking operations may generally be referred to as “wet cooking” operations, such as but not limited to pressure cooking, steam cooking, slow cooking, searing, and sautéing. To create a wet cooking environment the majority of the moisture within the container, i.e. liquid added to the container 24 or moisture released from the food within the container 24, is retained within the container as the food is cooked. Although during conductive cooking operations a minimal amount of air having moisture entrained therein may be vented from the system, such air is passively removed from the cooking enclosure. Similarly, the second cooking mode employs the second heating element 84 to perform convective heating operations. Convective heating operations may generally be referred to as “dry cooking operations,” which include any cooking mode that creates a “dry cooking environment” within the container 24, such as but not limited to air frying, broiling, baking/roasting and dehydrating. To create a dry cooking environment, air and moisture are actively exhausted or vented from the cooking enclosure to outside the cooking system 20, thereby maintaining a minimum level of moisture within the container 24. Parameters associated with the various exemplary but non-limiting cooking modes are shown at FIG. 13.

As is noted above, the first cooking mode of the cooking system 20 includes pressure cooking. In such embodiments, the secondary lid 37 is affixed to the container 24 or housing 22 to form a pressure-tight, sealed enclosure with the container 24. During operation in the pressure cooker mode, the controller 102 initiates operation of the first heating element 82, causing the temperature and therefore the pressure, within the enclosure formed by the container 24 and the secondary lid 37 to rise. During operation in the pressure cooker mode, the second heating element 84 disposed within the primary lid 32 is typically not energized. In an embodiment, the cooking system 20 may include a sensor S configured to monitor the pressure within the enclosure. Upon detection that the pressure is at or exceeds a predetermined threshold, the controller 102 may de-energize the heating element 82 until the pressure within the enclosure has returned to an acceptable level. Alternatively, or in addition, a pressure relief valve 51 (see FIG. 4) may be formed in the secondary lid 37, and may open to reduce the pressure within the enclosure to below the threshold. The pressure relief valve 51 may be configured to open automatically when the pressure is above the threshold, or the valve 51 may be coupled to the controller 102 and may be operable in response to a signal generated by the controller 102, for example in response to sensing a pressure above the threshold. In embodiments where the cooking system 20 is operable in a slow cooking mode, but not a pressure cooking mode, the liner 23 of the housing 22 may be formed from a light weight, cost effective material, such as aluminum for example. However, in embodiments where the cooking system 20 is operable in a pressure cooking mode, the liner 23 should be formed from a more rigid material capable of withstanding the pressure build up within the container 24. As is noted above, the first cooking mode of the cooking system 20 also includes slow cooking, steaming, searing, and sautéing. When the cooking system 20 is operated in one of these non-pressure modes, either the secondary lid 37 may be affixed to the container 24 or housing 22 or the primary lid 32 may simply be closed.

During slow cooking, steaming, searing, and sautéing (or other conductive cooking means that do not involve “pressure cooking”), the controller 102 initiates operation of the first heating element 82, causing the temperature within the container 24 and at the bottom surface thereof to increase. Upon detection that the temperature of the hollow interior 30 is equal to or exceeds a predetermined threshold, the controller 102 may de-energize the heating element 82 until the temperature has returned to an acceptable level. Such de-energization or power termination to the heating elements 82 and 84 based on detection of unsafe conditions by temperature or pressure sensors S will be discussed in greater detail below.

As previously suggested, the at least one input 94 is also usable to select operation of the cooking system 20 in a second cooking mode that employs convective cooking such as air frying. In an exemplary, non-limiting embodiment, air frying in the system 20 involves the use of various components such as the fan 90, and an insert 52 and diffuser 40.

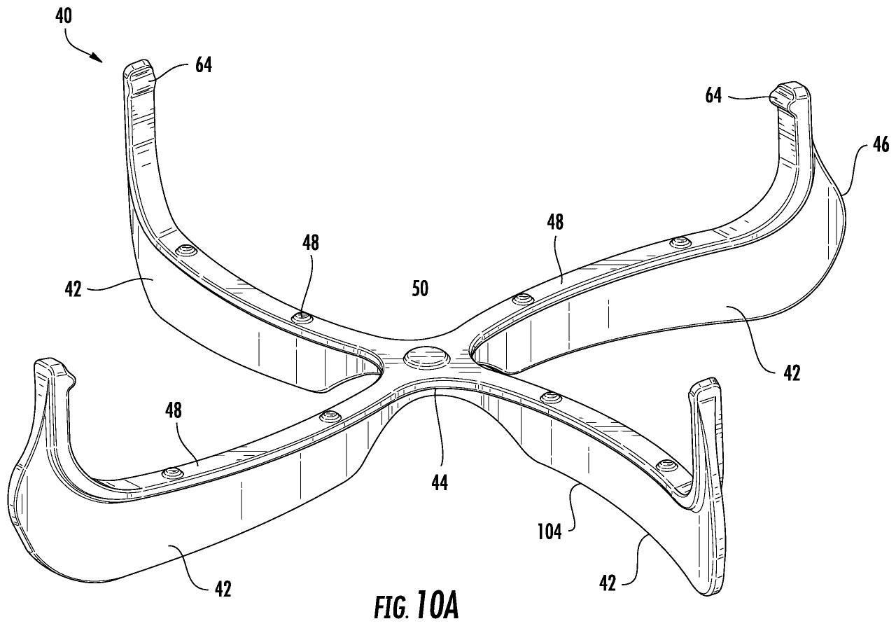

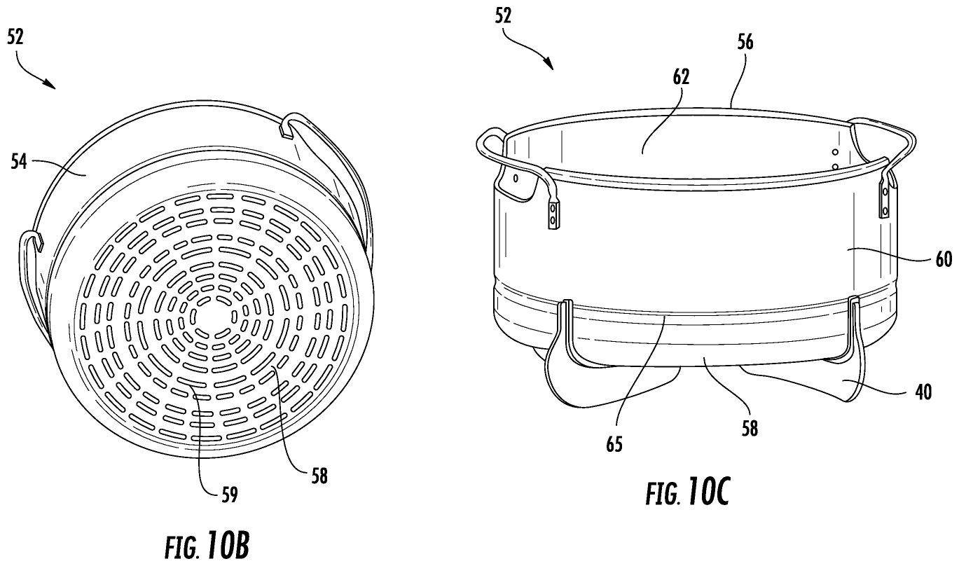

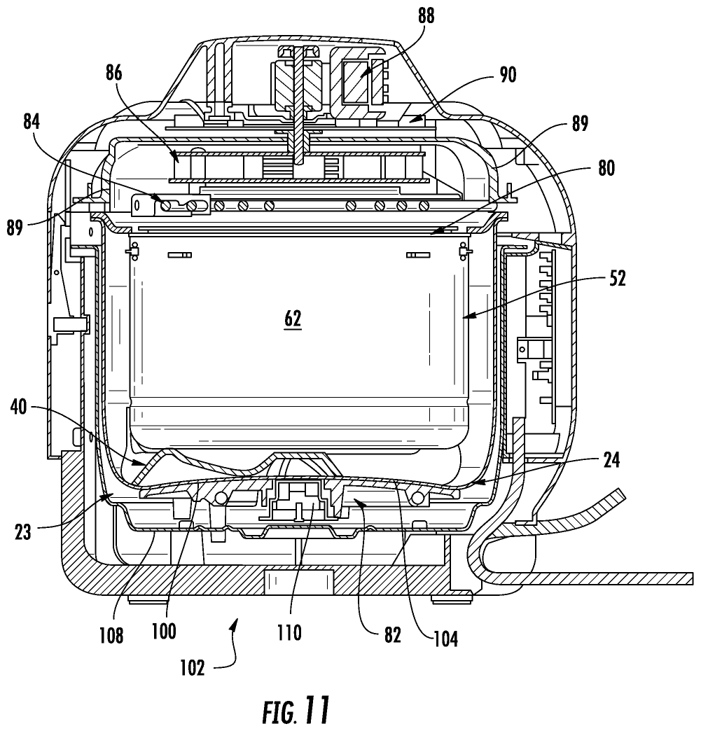

With reference now to FIGS. 10A-C and 11, an air diffuser 40 is shown. The diffuser 40 is an optional system component that may benefit air circulation during the air frying mode. The diffuser is positionable anywhere in the hollow interior 30 (though typically near the bottom). In an exemplary, non-limiting embodiment, the diffuser is positioned in contact with a bottom surface 31 of the container 24, and in conjunction with an insert 52.

As shown in the Figures, the air diffuser 40 may include a plurality of vanes 42 spaced about a center body 44. Each of the plurality of vanes 42 is configured to impart swirl to an air flow circulating through the container 24. With reference to FIGS. 10A-C and 11, the insert 52 includes a body 54 having a first, open end 56, second, aperture end 58, and at least one sidewall 60 extending between the first end 56 and second end 58 to define a hollow interior or chamber 62 defined by the body 54. The first end 56 is generally open to provide access for positioning one or more food items within the chamber 62. The second end 58 of the body 54 is partially closed to retain one or more food items within the chamber 62. In an exemplary, non-limiting embodiment, the closed second end 58 of the body 54 defines a plurality of apertures 59 (see FIG. 10B) to allow air, heat, and/or steam flowing within/through the interior 33 of the container 24 may pass through the apertures 59 in the end 58 to cook one or more food items within the chamber 62 of the body 54.

When the insert 52 is positioned within the area 50, in contact with the upper surface 48 of the air diffuser 40, and the insert 52 with air diffuser 40 is disposed within the interior 33 of the container 24, the bottom surface 58 of the insert 52 is positioned to be offset from the bottom surface 31 of the container 24. In an embodiment, the insert 52 is integrally formed with or coupled to the air diffuser 40. When the insert 52 and air diffuser 40 are arranged within the interior 33 of the container 24, such as during a convective cooking operation for example, an annulus 76 is formed between an inner surface 78 of the container 24 and the sidewalls 60 of the body 54 of the insert. Further, in an exemplary non-limiting embodiment the height of the insert 52, when installed within the container 24 with the air diffuser 40, may be generally equal to or less than height of the container 24. In embodiments where the cooking system 20 includes a secondary lid 37, either the primary lid 32 or the secondary lid 37 may be used, i.e. coupled to the upper surface 34 of the housing 22 when the insert 52 is positioned generally within the hollow interior 30 of the system 20 or specifically within the interior 33 of the container 24.

It should be appreciated that the insert 52 may also be received directly in the hollow interior 30 as opposed to within the container 24 within the hollow interior 30. That is, the insert 52 (and diffuser 40) may be disposed in the system without the container 24, and food may be cooked in the insert 52 in accordance with of the second mode, convective cooking functions.

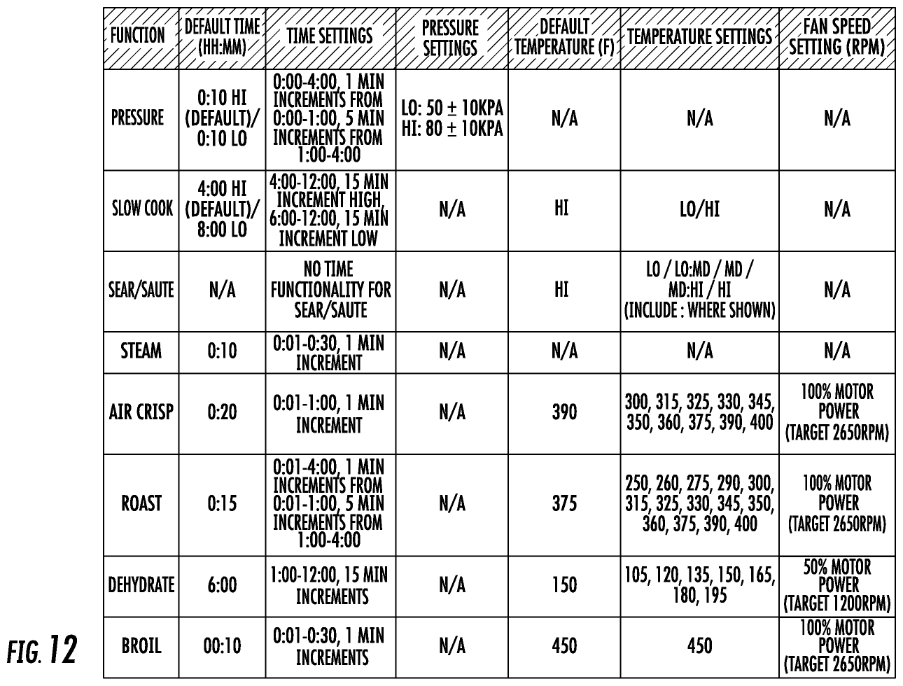

With further reference to second, convective cooking mode functions (particularly air frying modes), the second heating element 84 is configured to heat air as it passes there through via an air movement device 86, such as a fan for example. In embodiments where the insert 52 is arranged within the interior 33 of the container 24, the air movement device 86 draws air from the center of the insert 52, and moves it across the second heating element 84 before forcing the heated air through the annulus 76 between the container 24 and the insert 52 towards the clearance 74 formed between the bottom 58 of the insert and the bottom surface 31 of the container 24 (the arrows in FIG. 8 show exemplary air flow through the system). This air movement may be facilitated via air guides such as a skirt/air guide 89 that creates a non-sealing air guide for air into the annulus 76. In the illustrated, non-limiting embodiment of FIGS. 7 and 11, the air movement device 86 is driven by a motor 88 having a separate cooling mechanism 90 coupled thereto. In an embodiment, a vent 91 is formed in the primary lid for exhausting hot air generated by operation of either the air movement device 86, the motor 88, or the separate cooling mechanism 90 to the exterior of the cooking system 20. However, it should be understood that the second heating element 84 and the air movement device 86 may also be used to circulate air through the enclosure defined between the container 24 and the primary lid 32 when the insert 52 and/or air diffuser 40 are not arranged within the container 24. As is shown in the exemplary embodiments of the Figures, the at least one second heating element 84 is disposed within the primary lid 32. In an embodiment, the second heating element 84 has a diameter substantially equal to the diameter of the body 54 of the insert 52. However, embodiments where the second heating element 84 has a diameter smaller than or greater than the diameter of the body 54 of the insert 52 are also contemplated herein.

When utilizing the second heating element 84 in the air fryer mode, the controller 102 initiates operation of the second heating element 84 and the air movement device 86 to circulate the hot air represented by the arrows in FIG. 8 through the enclosure formed between the container 24 and the lid 32. During operation in the air fryer mode, the first heating element 82 is generally not energized. However, embodiments where the first heating element 82 is energized are also within the scope of the disclosure.

The air movement device 86 draws air upward through the adjacent heating element 84 and expels the hot air outwardly towards the guide 89 (which, in an exemplary embodiment, actually surrounds the fan 86). The guide 89 deflects the air downwardly towards the annulus 76 along the sides of the container 24 (again, please see the arrows in FIG. 8). The air travels down through the annulus 76 (still by actuation of the fan 86) until it is deflected off the bottom surface 31 of the container 24 and drawn up by the fan 86 into the clearance 74 up towards the diffuser 40 and end 58 of the insert 52 with the aperture pattern 59. The hot air flows over and between the plurality of vanes 42 of the air diffuser 40, which impart a rotational motion to the hot air, thereby creating a vortex as the air is drawn through the apertures 59 and into the chamber 62 of the body 54 by the air movement device 86. After traversing the chamber 62, the air is drawn back up through the heating element 84 and into the fan 86 for further circulation.

As the air circulates through the chamber 62 in the manner described above, the hot air cooks and forms a crispy outer layer on the food items disposed therein as a result of the Maillard effect. In an embodiment, a liquid, such as oil or fat, is contained within the enclosure, such as adjacent the bottom surface 31 of the container 24. The liquid may be added to the container 24 prior to operation in the air fry mode, or alternatively, may be produced as a residual material as the hot air passes over the food within the chamber 62. In embodiments where a liquid is disposed at the bottom of the container 24, as the air circulates through the interior 30 of the container 24, a portion of the liquid becomes entrained in the air flow and is heated.

As is best shown in FIG. 1A, in an exemplary embodiment the lid 32 includes a heater/fan cover 80 that protects a user from the heating element 84 and fan 86, and protects the heating element 84 and fan 86 from the areas 31,33,64 where food is cooked. The cover 80 may be included in embodiments of the cooking system 20 including only a primary lid 32, or alternatively, in embodiments including both the primary and secondary lids 32, 37. In the illustrated, non-limiting embodiment, the cover 80 is formed from a nano ceramic coated and is mounted to the primary lid 32, such as via one or more fasteners for example. In such embodiments, when the primary lid 32 is in the closed position, the cover 80 is arranged generally above the first open end of the container 24. The cover 80 has a plurality of openings 81 formed therein to allow hot air circulating within the interior 33 of the food container 24 to pass there through.

In another convection cooking embodiment, the second cooking mode of the cooking system 20 includes a dehydrator mode, such as used to make jerky for example. In such embodiments, the primary lid 32, is typically affixed to the food container 24 or housing 22, though the secondary lid 37 may also be used. When the cooking system 20 is operated in the dehydration mode, the air diffuser 40 and/or insert 52 may, but need not be, positioned within the interior 30 of the container 24. During operation in the dehydrator mode, air is configured to circulate through the container 24 in a manner similar to the air fryer mode.

In an embodiment, the air movement device 86 of the cooking system 20 is a variable speed fan operable at a plurality of rotational speeds. In an embodiment, the operational speed of the air movement device 86 may vary based on the cooking mode selected (see the exemplary, non-limiting parameters and speeds set forth in FIG. 13). For example, the speed of the air movement device 86 during operation in an air fryer mode may be different than the speed of the air movement device during operation in a dehydrator mode. The operational speed of the air movement device 86 may be controlled by the controller 102 in response to one or more inputs 94, including selection of a cooking mode. However, the controller 102 may also be configured to adjust the operational speed of the air movement device 86, or alternatively, the power supplied to the one or more heating elements 82, 84, to control the temperature and/or pressure within the hollow interior 30 of the container 24.

The first and second heating elements 82, 84 are operable independently or in combination to apply one or more predetermined power settings to cook the food products within the container 24 and/or insert 52. In operation, the heating elements 82, 84 are capable of cooking the food products independent of the loading of the food products. In other words, the heating elements 82, 84 are capable of cooking the food products independent of the amount of food products within the container 24.

In some embodiments, the cooking system 20 is operable in more than two cooking modes. For example, the cooking system 20 may be independently operable in any of a slow cooking mode, a pressure cooking mode, an air fryer mode, and a dehydrator mode. Alternatively, or in addition, the at least one input 94 may be used to select operation of the cooking system 20 in a cooking mode that functions as a combination of two or more cooking modes. In such embodiments, the controller 102 may execute a stored sequence where the first heating mechanism 82 is operated during a first portion of the sequence and the second heating mechanism 84 and air movement device 86 are operated during a second portion of the sequence. For example, in the combination mode, a food item, such as a chicken for example, may be slowly cooked or pressure cooked via operation of the first heating element 82. Then, the second heating element 84 and the air movement device 86 may be operated to air fry the chicken to achieve a crispy exterior layer. However, the embodiments described herein are intended as an example only and any sequence of operation combining both the first and second heating elements is contemplated herein. When operated in a combination of two or more cooking modes, such as a pressure cooker and an air fryer, the food need not be removed from the hollow interior 30, or more specifically the container 24, or even more specifically from the chamber 62 of the insert 52 during such a transition.

As is alluded to above, the food container 24 may be usable in both the first and second cooking modes. In an exemplary embodiment, convective cooking (first mode), and more specifically air frying is possible in a container (such as container 24) that is deformable for use in a pressure cooking environment (second mode). Containers in which pressure cooking occurs may deform elastically in response to pressure conditions within the pot during cooking. A “domed” or curved shape 150 in a bottom surface 112 (see FIG. 12) of pressure pot such as container 24 may also be employed to handle pressure conditions and the deformity that may result therefrom. Accordingly, since the container 24 may also be used as an air frying chamber, exemplary embodiments of air frying components such as the insert 52 and diffuser 40 may be configured for use in pressure cooking environments. For example, the diffuser 40 may include a curved or sloped bottom surface 104 that conforms to the domed/curved/sloped shape 150 of the bottom surface 202 of the food container 24. Indeed, the bottom surface 104 of the air diffuser 40 may be curved or sloped to conform to a potentially domed surface of any container (again, such as container 24) used in for wet cooking modes such as but not limited to pressure, steam, slow cooking.

In accordance with the above, the insert 52 may be placed in the container 24 with food to be cooked in the first and second modes consecutively. For example, the insert 52 may be placed in the container 24 and food may be placed within the insert for cooking in a first, conductive modes such as pressure or slow cooking. The cooking system 20 may then be switched into the second, convective mode, and the food still contained in the insert 52 contained in the container 24 can be cooked in accordance with a convection heating function. In an exemplary embodiment involving pressure cooking and air frying, such a process would involve placing food in the insert 52 and placing the insert in the container 24. The secondary lid 37 would be affixed to the cooking system 20 and pressure cooking would/could occur. Once the pressure cooking is complete, the secondary lid 37 would be removed and replaced with a closed primary lid 32. The food may then be air fried, with all the cooking occurring within the insert 52 disposed within the container 24. Of course, while food would most commonly be cooked first in a conductive/wet mode followed by a convective/dry mode, the cooking system 20 is certainly capable of cooking food first in a convective/dry mode followed by a conductive/wet mode.

The cooking system 20 illustrated and described herein provides an enhanced user experience by combining the functionality of several conventional household products into a single user-friendly device.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Exemplary embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A cooking system for cooking food, the cooking system comprising:
a housing defining a hollow chamber,
a food container positionable in said hollow interior and defining a container interior;
at least one heating element positioned in said housing to heat said container interior,
wherein said food container includes a non-elliptical container shape,
wherein said container interior is structured to tolerate a high pressure cooking environment; and
wherein said housing includes a non-elliptical housing shape.

2. The cooking system of claim 1, wherein said non-elliptical container shape is the same or similar to said non-elliptical housing shape.

3. The cooking system of claim 1, wherein said non-elliptical container shape and said non-elliptical housing shape are squircle shaped.

4. The cooking system of claim 1, wherein said high pressure cooking environment reaches a pressure of at least 70 kPa.

5. The cooking system of claim 1, wherein said high pressure cooking environment reaches a pressure of between 40 kPa and 100 kPa.

6. The cooking system of claim 1, wherein said hollow interior of said housing includes a non-elliptical shape that is the same or similar to said non-elliptical container shape.

7. The cooking system of claim 1, wherein said at least one heating element is a heating element disposed below said food container.

8. The cooking system of claim 1, wherein said at least one heating element is a heating element disposed above said food container.

9. The cooking system of claim 1, wherein said at least one heating element is a first heating element disposed below said food container and a second heating element disposed above said food container.

10. The cooking system of claim 1, wherein a thickness of said food container varies about a perimeter of the food container.

11. The cooking system of claim 10, wherein said food container has a plurality of sides connected by a plurality of rounded corners and a thickness of said food container at at least one of the plurality of rounded corners is greater than a thickness of said food container at at least one of the plurality of sides.

12. A cooking system for cooking food, the cooking system comprising:
a housing defining a hollow chamber,
a food container positionable in said hollow interior and defining a container interior;
at least one heating element positioned in said housing to heat said container interior,
wherein said food container includes at least one first wall area and at least one second wall area, said at least one first wall area including a greater fortification for stress tolerance than said at least one second wall area.

13. The cooking system of claim 12, wherein said container interior is structured to tolerate a high pressure cooking environment.

14. The cooking system of claim 13, wherein said high pressure cooking environment reaches a pressure of at least 70 kPa.

15. The cooking system of claim 13, wherein said high pressure cooking environment reaches a pressure of between 40 kPa and 100 kPa.

16. The cooking system of claim 12, wherein said food container includes a non-elliptical container shape.

17. The cooking system of claim 12, wherein said food container includes a squircle container shape.

18. The cooking system of claim 12, wherein said food container includes a plurality of sides extending between a plurality of rounded corners, said at least one first wall area including one of the plurality of rounded corners and said at least one second wall area including one of the plurality of sides.

19. The cooking system of claim 12, wherein said at least one first wall area includes a first thickness and said at least one second wall area includes a second thickness, said first thickness being greater than said second thickness, said greater fortification for stress tolerance being formed by said first thickness.

20. The cooking system of claim 12, wherein said at least one heating element is a heating element disposed below said food container or above said food container.
